(19) United States
(12) Patent Application Publication
(10) Pub. No.: US 2013/0315362 A1
(43) Pub. Date: Nov. 28, 2013

(54) NUCLEAR DIGITAL INSTRUMENTATION AND CONTROL SYSTEM

(71) Applicant: TING-CHIA OU, Taoyuan County (TW)

(72) Inventor: TING-CHIA OU, Taoyuan County (TW)

(73) Assignee: Institute of Nuclear Energy Research Atomic Energy Council, Executive Yuan, Taoyuan County (TW)

(21) Appl. No.: 13/481,274

(22) Filed: May 25, 2012

(51) Int. Cl. G21C 7/36

(52) U.S. Cl. 376/216

(57) ABSTRACT

A nuclear instrumentation and control system, comprising: an input module, receiving analog inputs from sensors and digital signals from hardware switches; a dual redundant bi-stable processor, connecting to the input module; a dual redundant local coincidence logic processor, connecting to the dual redundant b0-stable processor; an output module, connecting to the dual redundant local coincidence logic processor; an integrated communication processor, connecting to the dual redundant bi-stable processor and the dual redundant local coincidence logic processor; an interface and test panel, connecting to the dual redundant bi-stable processor, the dual redundant local coincidence logic processor and the integrated communication processor; and a video display unit, connecting to the dual redundant bi-stable processor, the dual redundant local coincidence logic processor, the integrated communication processor and the interface and test panel. Thereby, a qualification and certification tools for design and development of safety related equipment and explains the basis for many decisions made while performing the digital upgrade.

### FIELD OF THE INVENTION

The present invention generally relates to a nuclear instrumentation and control system, and more particularly to a nuclear instrumentation and control system capable of using processor modules to communicate and communicating with FL-net to obtain stable signals.

### BACKGROUND OF THE INVENTION

The age of the operation nuclear power plants (NPPs) currently operating in Taiwan exceeds 30 years. Thus the need for upgrading will inescapably grow in the next future. Most of the installed Nuclear Instrument and Control (NI&C) systems are based on analog technologies including analogue electronic modules, electromagnetic relays etc. As the NI&C systems become older, they may experience a higher failure rate with associated increased maintenance costs. Analog control systems of a nuclear power plant have performed their intended monitoring and control functions satisfactorily. The primary concern with the extended use of analog systems is effects of aging such as mechanical failures, environmental degradation, and obsolescence. The obsolescence is driving many utilities to implement upgrades to both their safety and non-safety-related. The technical solutions currently available on the market mainly count on digital technologies such as microprocessors, hardware, and software. The digitalized and computerized control systems are essentially free of the drift that afflicts analog electronics, so the scale can be maintained better. They are relatively new for NI&C systems and are raising many technical and procedural issues such as the quantification of software reliability. The digitalized and computerized also have the potential for improved capability such as fault tolerance, self-testing, signal validation, process system diagnostics etc, which could form the basis for entirely new approaches to achieve the required reliability.

Taiwan has three NPPs under commercial operation and one plant named Lungmen under construction. Taiwan has strong capability of design and manufacturing in electronic and digital components, but it did not have its NI&C system. In order to achieve a technical self-reliance in the field of NI&C, the Institute of Nuclear Energy Research (INER) had a leading role to promote the Taiwan's NI&C system (TaiNICS) project (Shyu, Shian-Shing & Lee, Chung-Lin 2009 Introduction of Taiwan's Nuclear Instrumentation and Control System (TaiNICS). International Workshop on the Establishment of TaiNICS, Lungtan, Taiwan (R.O.C.), October 19-20) in developing the nuclear-grade PLC(programmable logic controller) and digital NI&C systems. TaiNICS is a joint effort mainly from Taiwan's research institutes and electronic companies. Right now, INER and Formosa Plastics Corporation (FPC) are the main promoters. It also includes participants such as AAEON Company, ICPDAS Company, Electronic Test Company (ETC), E&C Engineering Corporation, other international supports etc.

### SUMMARY OF THE INVENTION

The purposes of this invention are planned to support digital upgrade of the existing NPPs and the new digital NI&C installations in Taiwan. All the critical components are implemented using Taiwan's electronic components, for example, the Industry Computer based processor module and I/O modules are supplied by AAEON and ICPDAS companies, respectively. FPC has been applying and maintaining its control system[1].

Although the new digital systems can provide adaptability and enhanced capabilities, they also induce new failure modes, which differ from that of analog system. Therefore, the invention can be a long term pursuit of several task branches, including establishment of a generic qualified digital platform determining the complexity of digital I&C systems and its correlation to reliability, qualification and certification processes, NI&C systems design, safety analyses for software common cause failure, licensing, and collaboration.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 illustrates an architecture of a processor module.

FIG. 2 illustrates a mechanism of cyclic FL-net which is token-passing ring and only one node broadcasts messages sequentially.

FIG. 3A shows an overview of the TaiNICS DI&C(digital instrument and control) architecture.

FIG. 3B shows a connection diagram for the inter-divisional module.

FIG. 3C shows the proposed Ethernet-based token pass protocol system architecture.

FIG. 3D illustrates a typical 4-division DRPS 2.

FIG. 3E shows an Architecture of the ESFAS.

FIG. 3F shows a safety control system architecture.

FIG. 4 illustrates a dual redundant configuration within single division.

FIG. 5 illustrates a system architecture of Ethernet based token pass protocol.

FIG. 6 illustrates a bus model of the Ethernet.

FIG. 7 illustrates a packet is sent from node 2.

FIG. 8 illustrates node 255 broadcasts the packet of FIG. 7.

FIG. 9 illustrates other nodes receive the packet of FIG. 7.

FIG. 10 illustrate a packet is sent from node 3.

FIG. 11 illustrate node 255 broadcasts the packet of FIG. 10.

FIG. 12 illustrates node 254 broadcasts a packet.

FIG. 13 illustrates node 254 fails and node 255 is active.

FIG. 14 illustrates a packet is sent from node 2.

FIG. 15 shows a packet is sent from node 3.

FIG. 16 shows node 255 broadcasts packets.

FIG. 17 shows nodes 4 and 5 fail.

FIG. 18 shows a packet a packet is sent from node 6.

FIG. 19 shows node 255 broadcasts the packet.

FIG. 20 shows the queuing delay performance without failure-recovery events in different offered loads.

FIG. 21 is the queuing delay variance performance diagraph in different offered loads.

FIG. 22 shows throughput performance in different offered loads.

FIG. 23 is the delay performance diagraph with exponential distribution control units' failure-recovery events time in different offered loads.

FIG. 24 is the delay variance performance diagraph with exponential distribution control units; failure-recovery event time in different offered loads.

FIG. 25 shows throughput performance in different offered loads.

FIG. 26 is the switch-hub's reliability in performance diagraph with or without switch-hub's failure event.

### DESCRIPTION OF THE PREFERRED EMBODIMENT

Referring now to the drawings where like characteristics and features among the various figures are denoted by like reference characters.

In order to facilitate the development of NI&C system, all aspects of the existing NI&C system and its documentation are researched. The information obtained is used to confirm interface termination detail, document present NI&C parameters set points, among other parameters. TaiNICS of this invention compared to the specification to the generic requirements of nuclear safety controller, the EPRI TR-207330 (EPRI TR-107330 1996 Generic Requirements Specification for Qualifying a Commercially Available PLC for Safety-Related Applications in Nuclear Power Plants, The Electric Power Research Institute, California, US). A complete set of system logic diagrams which documented system functional requirements are generated. These are the key design specification for the TaiNICS (Shyu, Shian-Shing & Lee, Chung-Lin 2009 Introduction of Taiwan's Nuclear Instrumentation and Control System (TaiNICS). International Workshop on the Establishment of TaiNICS, Lungtan, Taiwan (R.O.C.), October 19-20; and Lee, Dong-Young; Kwon, Kee-Choon; Kin, Chang-Hoi; Kim, Dong-Hoon; Hur, Seop & Lee, Jang-Soo 2008 Development Experience of a Digital Safety System in Korea. IAEA Technical Meeting, Beijing, China, November 3-6). In order to setup the specification of the safety NI&C platform, under collaboration task between INER and FPC, a deviation analysis is compared between the safety platform requirements of EPRI TE-107330 and the existing specification of FPC. The result provides a similar function for the control portion of the upgrade which is designed.

In order to pass the licensing process of replacing a safety-related NI&C system by newly design digital system like x-86 architecture Industry Computer. The development of new system should meet the regulator requirements such as EPRI TE-107330. The software application or firmware should be not changed a lot for newer x-86 processor or chip set. Nowadays the x-86 architecture is used broadly and hard to be replaced. Therefore the problems like stop producing or lacking backups should not occur. So obsolescence issues can be resolved by using an x-86 based system.

The development of NI&C system is implemented with the Formosa Controller System (FPC) which is a commercial Digital Controller System(DCS) (Hsieh, Si-Fu; Wu, Tsung-Hsun & Su, Yu-Kuan 2009 Digital Controller Design and Application in Taiwan. International Workshop on the Establishment of TaiNICS, Lungtan, Taiwan (R.O.C.), October 19-20) developed by FPC. To fulfill the specifications of generic requirements of nuclear safety related controller according to TR-107330, the modification of component in FCS is described as below.

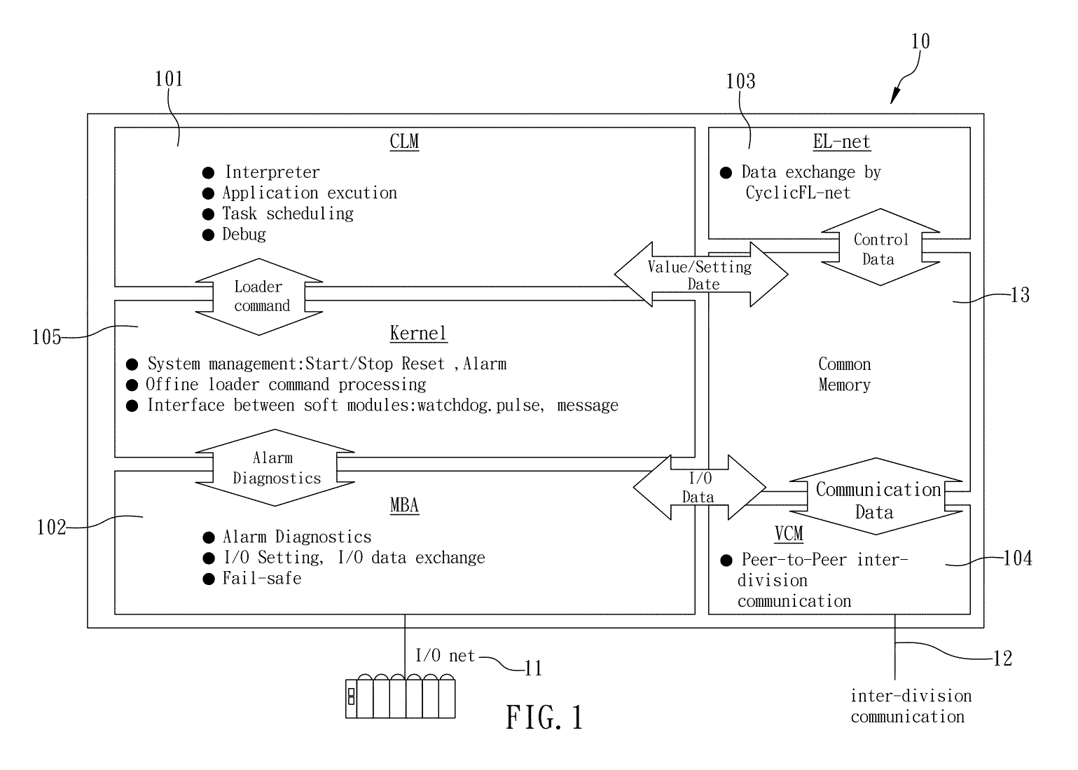

For processor module, FCS utilizes an x86-based Industry Computer processor module. Please refer to FIG. 1, it is illustrated an architecture of a processor module. The processor module 10 includes main processor (not shown), mother board (not shown), I/O-net port 11, inter-division fiber-optical communication ports 12, intra-division FL-net communication ports (not shown) and dual redundant power (not shown). The processor module 10 utilizes a simplified BIOS and QNX ver. 6.4 as the Real Time Operating System (RTOS). It has the characteristics of memory management unit (not shown), inter-process communication (not shown), self-healing mechanism (not shown), and a variety of device drivers (not shown). There are five software modules in the processor module 10 including Controller Logic Module (CLM) 101, Multiple Bus Access module (MBA) 102, FL-net module 103, Vital Communication Module (VCM) 104 and kernel 105.

For inter-division communication, Each single division Processor transfers its signals to all division Processors (one is in local division and the other in the other division), which means so-called “inter-division”. Inter-Division Communication is an important issue in safety-related nuclear system (Shyu, Shian-Shing & Lee, Chung-Lin 2009 Introduction of Taiwan's Nuclear Instrumentation and Control System (TaiNICS). International Workshop on the Establishment of TaiNICS, Lungtan, Taiwan (R.O.C.), October 19-20; DI&C-ISG-04 2004 Highly-Integrated Control Rooms—Communications Issue (HICRc), United States Nuclear Regulatory Commission, Washington D.C., US). In the specification of TE-107330 requirements, it should be deterministic (i.e. the time it takes to achieve the communication should be well-defined), and any other portion of the safety-related function cannot be inhabit or stop by communication errors.

In order to fulfill specifications of inter-division, some sort of special design is required. The implementation of inter-division communication in TaiNICS project is provided with the following properties: 1. no interrupts to processor from communication ports; 2. electrical isolation by optical fiber; and 3. one-way communication mechanism.

The mechanism of inter-division communication in TaiNICS is with enhanced RS-485 protocol deterministically and periodically. The communication module received data from processors and stores them to a receive buffer on common memory 13 by the dedicated processor, then the main processor acquires the data by polling the receive buffer periodically. Each communication module contains a dedicated processor, which executes CRC procedure, data send/receive and common memory access without affecting the operation of main processor. There is no handshaking between processors and only one-way in inter-division communication.

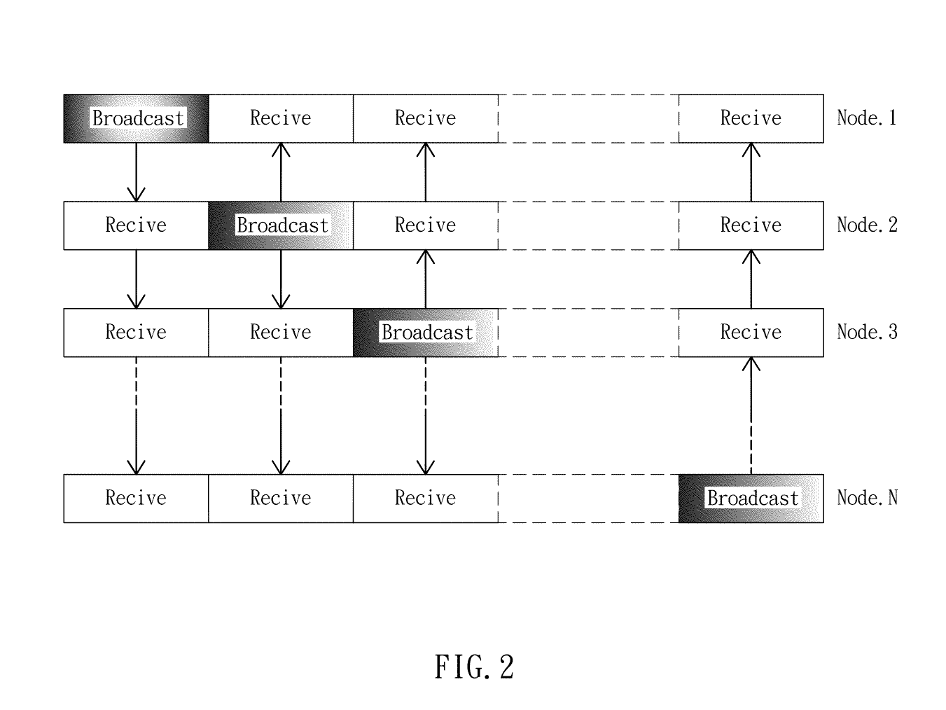

For intra-division communication, the intra-division communication is to exchange signals between module units in the same division. The TaiNICS project achieves Intra-division communication by cyclic FL-net and with a dual-ring redundancy. Fl-net is a standard of Japan Electrical Manufactures Association (JEMA) which is an Ethernet-based protocol (JIS B 3521 2004 Protocol specification for EA control network standard, Japanese Industrial Standard (JIS), Tokyo, Japan; and JEM TR-214 2000 Device profile common specification for EA control network, Japan Electrical Manufactures Association (LEMA), Tokyo, Japan). The cyclic Fl-net is a ring topology (Bus/Star topology physically), and it exchanges signals deterministically. The mechanism of cyclic FL-net is token-passing ring, and only one node broadcasts messages sequentially shown as FIG. 2. The network can be used as a share memory. Each node broadcasts its local signals to other nodes via FL-net as to refresh the share memory and each node gets necessary signals from FL-net into its own memory space.

The microprocessor-based system might be trapped into an unintended loop due to power surge, electro-magnetic wave or software failure. In nuclear safety-related applications, the controller shall provide recovery capability to recover controller from fault state. The watchdog timer monitors operations of the main processor and in normal condition the main processor actives a “heartbeat” signal periodically to trigger the watchdog timer reset. In case a fault occurs in controller, heartbeat signal is unable to trigger the watchdog timer reset in certain amount of time, and then the circuit of watchdog timer will reset the controller. The watchdog timer reduces the time to detect and identify failures. The design of watchdog timer for TaiNICS project is provided with the following properties: 1. When controller is unable to reset the watchdog timer in time, the watchdog timer sets the outputs of controller into failure-safe state; 2. The watchdog timer shall not depend on the same clock source as main processor; 3. The watchdog timer shall be implemented as independent hardware; 4. The operation of watchdog timer shall not be defeated or paused by any communication function; 5. The operation of watchdog timer shall not be defeated or paused by ant interrupt service function; 6. It would provide indicators or ability to latch an alarm when the reset condition is set by the watchdog timer; and 7. Passive watchdog timer design.

The FCS controller transfers information between the main processor and I/O module via a Multiple-Bus-Access bus (based on Modbus real-time protocol) (Hsieh, Si-Fu; Wu, Tsung-Hsun & Su, Yu-Kuan 2009 Digital Controller Design and Application in Taiwan. International Workshop on the Establishment of TaiNICS, Lungtan, Taiwan (R.O.C.), October 19-20), different from backplane bus transmission in conventional PLC design. The connection between I/O and processor provides dual line redundancy architecture. It is a high security and robust protocol and supports maximum 4096 digital signals, or 1024 analog signals in single controller with 100 Mbps Ethernet transmission rate. All design specifications of I/O modules comply with the requirements of EPRI TR-107330 to assure their reliability in nuclear safety-related application.

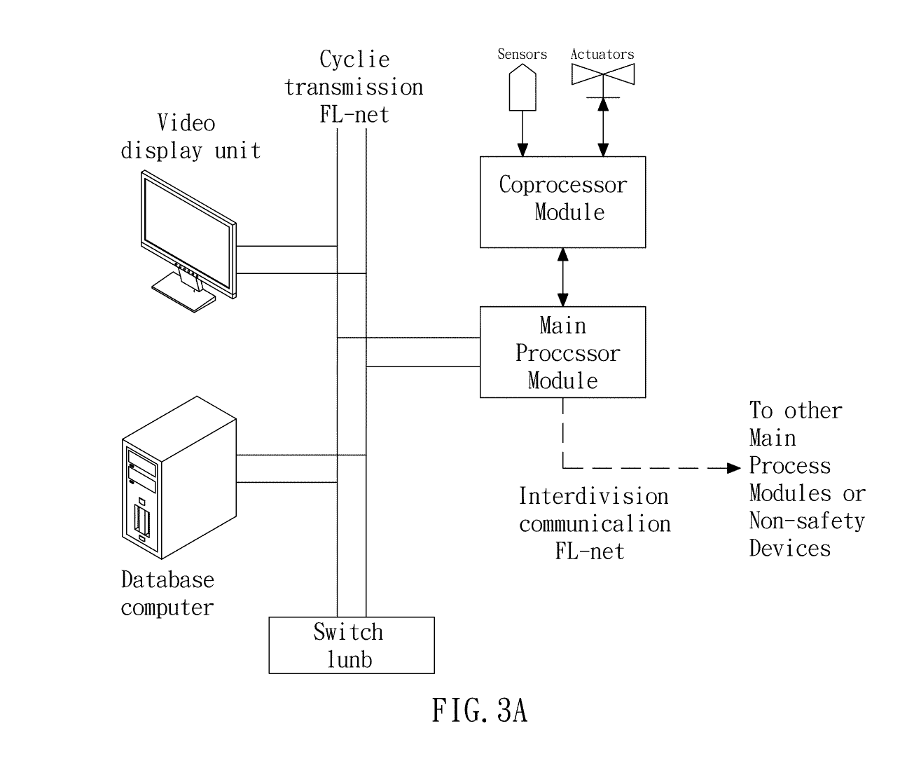

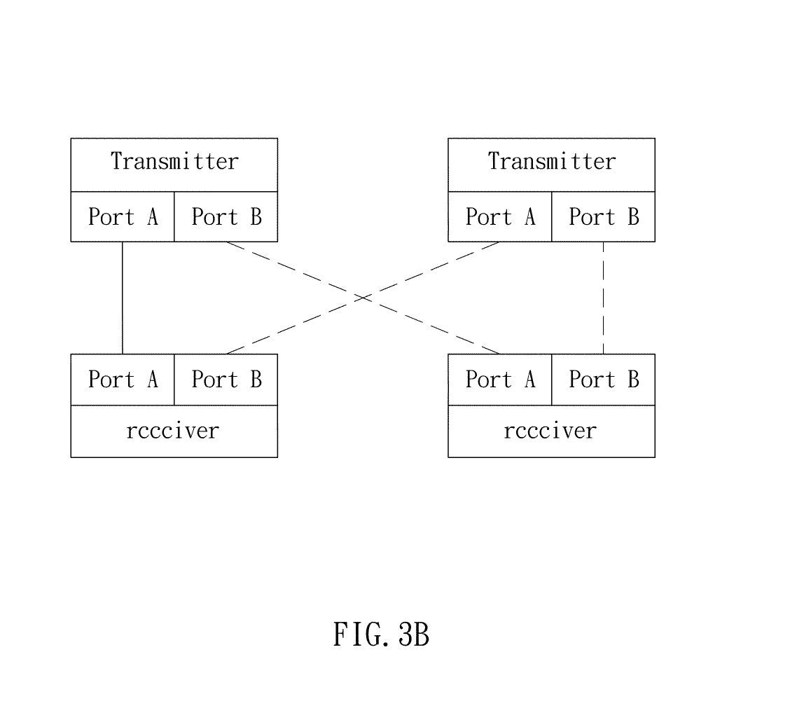

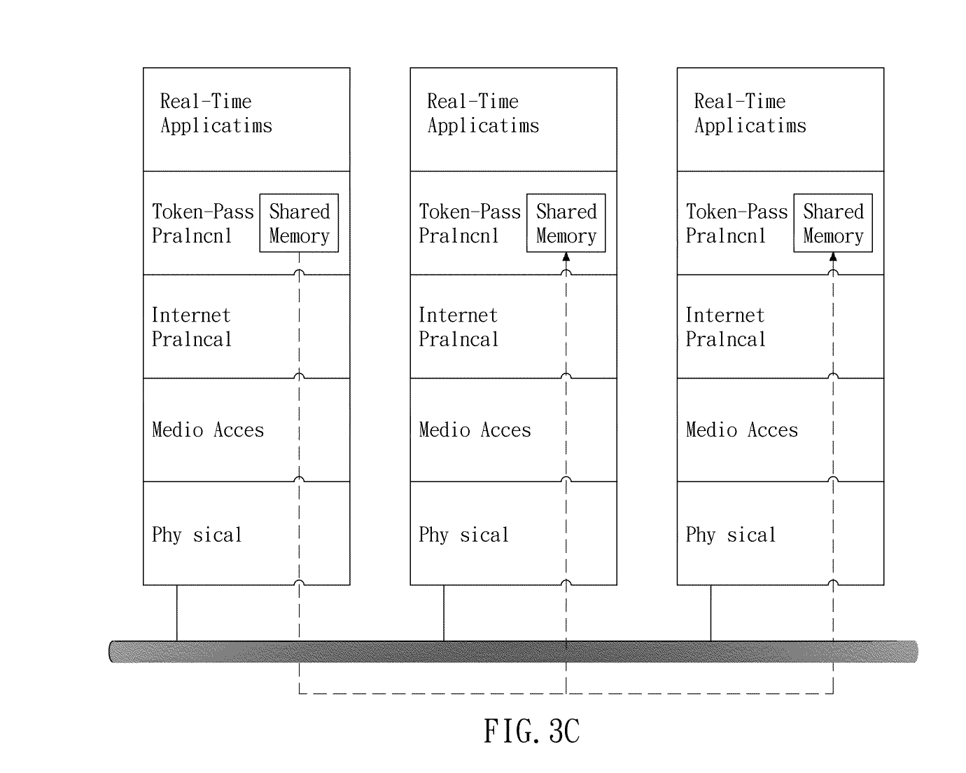

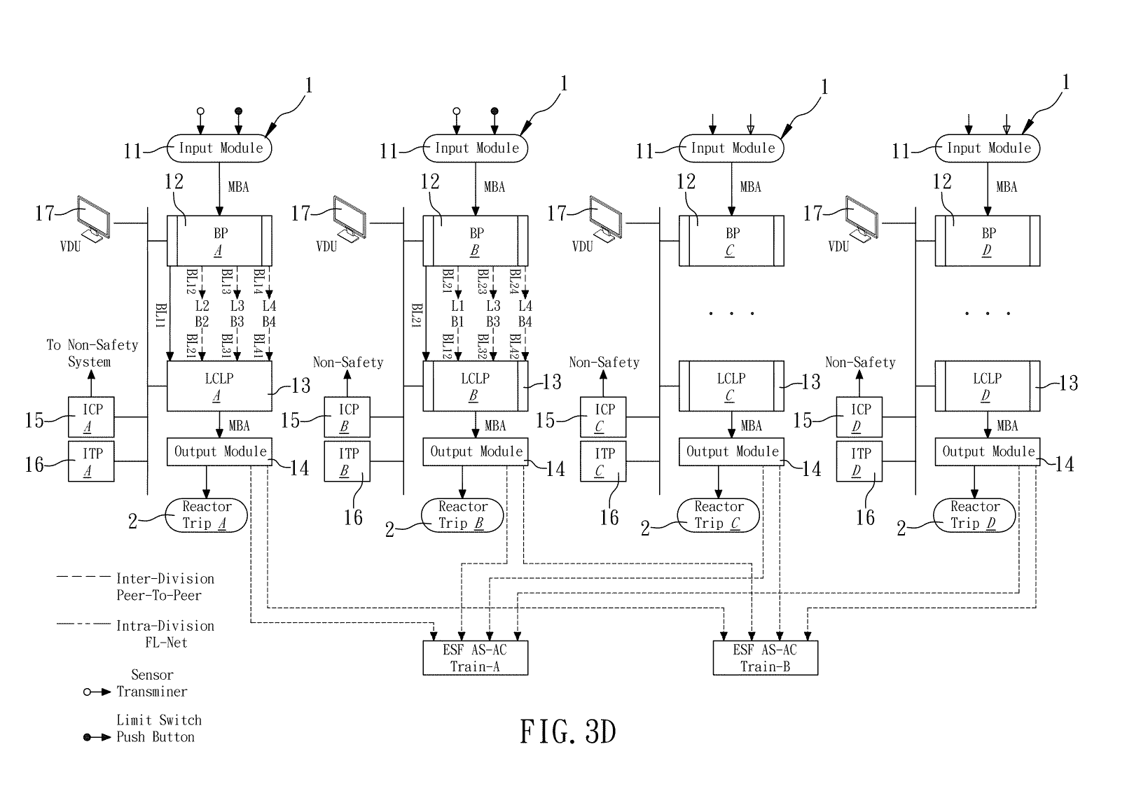

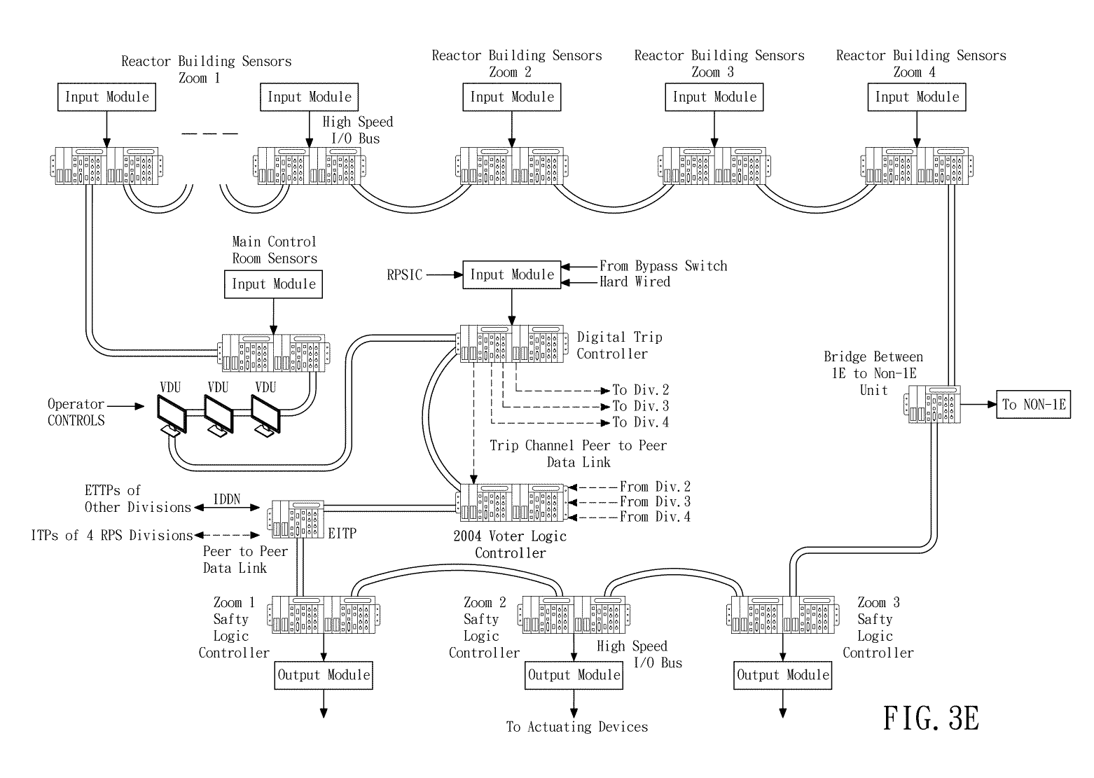

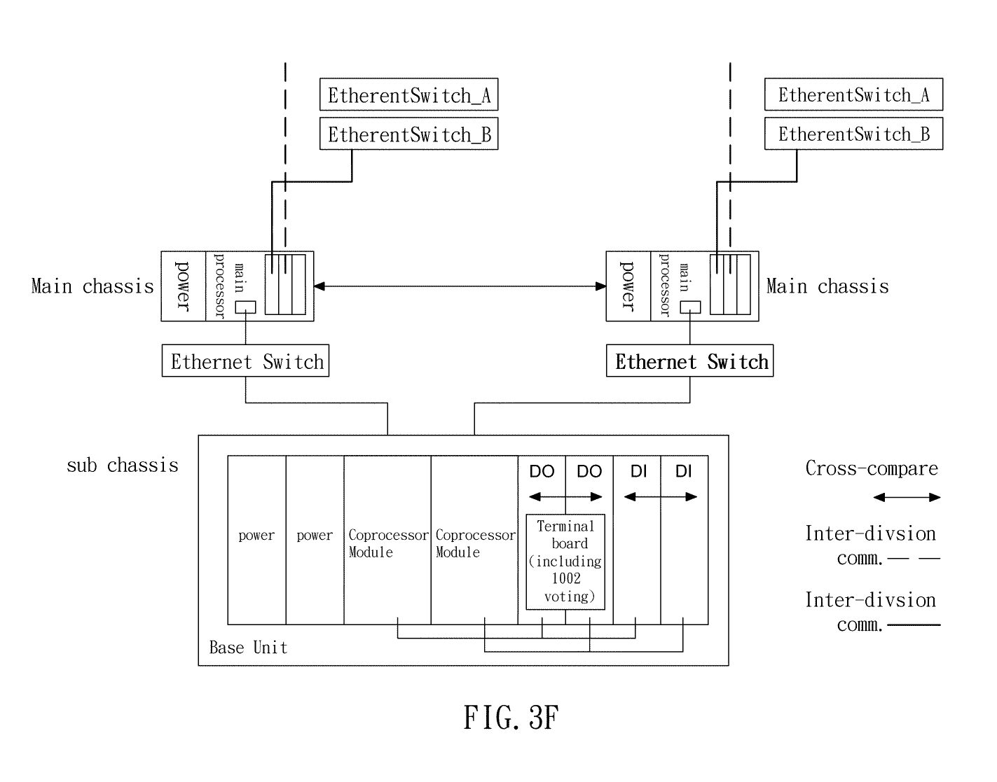

Please refer to FIGS. 3A, 3B, and 3C, which FIG. 3A shows an overview of the TaiNICS DI&C(digital instrument and control) architecture, FIG. 3B shows a connection diagram for the inter-divisional module, and FIG. 3C shows the proposed Ethernet-based token pass protocol system architecture.

The general control system in NPPs can be divided into three main parts: sensor, control logic and actuator. In some systems, other auxiliary components, such as a video display unit (VDU), operator interfaces or Data Logger Computer are also required, and it is a challenge to integrate the various signal forms or data formats in these. The goal of the TaiNICS DCSs design is to implement a model that can be extensively adopted in the DI&C system used in NPPs. Signals from field sensors or actuators are sent to the Coprocessor Module, where they are digitized and coded, and then sent to the Main Process Module via a real-time client and server (RTCS) net. The Main Processor Module integrates the signals it receives and executes the system application functions. The control network is called the Factory automation Link network (FL-net), which is a standard of the Japan Electrical Manufactures Association (JEMA) and is an Ethernet-based protocol. The data communication between the Main Processor Module and the auxiliary devices is handled by FL-net.

The development of the nuclear DI&C system is implemented with the Formosa Controller System (FCS), which is a commercial Digital Controller System [4]. To fulfill the specifications of the generic requirements of a nuclear safety related controller according to TR-107330, the modification of components in FCS is as described below.

FL-net is the controller level network which is complemented by the device-level network. FL-net is based on Industrial Ethernet, and is designed to provide intercommunication between controllers such as PLC, CNC or robot controllers from different manufacturers based on the public standard. The communication protocol used to implement the cyclic transmissions was developed by the Factory Automation (FA) Control Network Expert Committee at the Manufacturing Science and Technology Center (MSTC), and it is intended to be a domestic/international standard for an open FA network, known as the FL-net protocol. The basic concept of this Ethernet-based FL-net protocol is as follows: (a) to utilize Ethernet as the physical and data link communication media layers among FA controllers; (b) to offer basic transmission using the widely used UDP/IP protocols over Ethernet; and (c) to manage/control access to each node in the network to the above-mentioned transmission approach (to avoid collisions), while guaranteeing that transmissions will be completed within a fixed time. There are two communication scenarios in the FL-net used by the TaiNICS DCSs, inter-division and intra-division communication, and these will be explained in more detail later in this work.

FCS utilizes an x86-based Industry Computer processor module. The processor module includes the main processor, mother board, I/O net port, inter-division fiber-optical communication ports, intra-division FL-net communication ports and dual redundant power. The processor module utilizes a simplified BIOS and QNX Ver. 6.4 as the Real Time Operating System (RTOS). It serves as a memory management unit and also has the characteristics of enabling inter-process communication and self-healing, and contains a variety of device drivers. There are five software modules in the processor module, namely the Controller Logic Module (CLM), Multiple Bus Access module (MBA), FL-net module, Vital Communication Module (VCM) and kernel. Each module exchanges data via a common memory. The architecture of the processor module is depicted in FIG. 3A.

In the general design of nuclear power plants, a safety system, such as reactor protection system (RPS), always has several redundant channels in different locations to prevent damage by common cause failures, such as fires, floods or earthquakes. Each redundant channel has the same or a similar configuration, and even if failure occurs in a single redundant channel, the remaining ones can execute the system function without interruption. The system can thus tolerate failure in one or more redundant channels. A redundant channel is also called a division, and in some applications the data in a single division needs to be transferred to another division, which is known as inter-division communication, and this is an important issue in safety-related nuclear systems [1], [6]. In the specifications of the TR-107330 requirements, such communication should be deterministic (i.e. the time it takes to achieve the communication should be well-defined), and any other portion of the safety-related function cannot be inhabited or stopped by communication errors.

In order to ensure independence between divisions and prevent electrical interference, optical fiber is used in the wiring, which also provides isolation between the non-safety and safety systems, and enables the unidirectional transfer protocol to fulfill the both cyber security and time deterministic. A special design is required in order to fulfill the specifications of inter-division communication, and the hardware for the inter-division communication module in TaiNICS project has the following elements and properties: (a) An independent processor to handle the communication; (b) The independent processor will not interrupt the main processor, and provides a dual port memory interface for transferring data to the main processor module; (c) The inter-division communication module has two fiber optic connecting ports, which are the transmitter and receiver ports for peer-to-peer connection. By the one-way communication mechanism, the data is only sent from the transmitter port to the receiver port in two different modules. This unidirectional communication mechanism can avoid net congestion in communication; (d) The physical connection is a 1000 Mbps fiber Ethernet, and the links between each node are peer-to-peer ones without a switching hub; (e) The network transmission time between the different memories of the peer nodes should be less than 20 ms for 64 Bytes data length; and (f) The module provides a watchdog circuit which is able to control an LED indicator or an alarm signal.

The mechanism for inter-division communication in TaiNICS is based on an enhanced RS-485 protocol that operates deterministically and periodically. Each communication module contains a dedicated processor, which executes a cyclic redundancy check (CRC) procedure, in which the data is sent/received and the common memory accessed without affecting the operations of the main processor. There is no handshaking between processors and inter-division communication is only one-way.

The TaiNICS project has proposed a special design to meet the inter-division communication specifications in nuclear regulation. The inter-division communication module has two fiber optic connection ports. In peer-to-peer communication, each transmitter and receiver provides an inter-division communication module, and the module can be assigned as a transmitter or receiver by changing the software settings. The module only uses one port in the transmitter or receiver, and the other one port is reserved for the redundant configuration Here the redundant configuration means two or more controllers in the same channel, and this is different from having one redundant channel. A connection diagram for the inter-divisional module is shown in FIG. 3B.

The intra-division communication is undertaken to exchange signals between module units in the same division. The TaiNICS project achieves intra-division communication by using the cyclic FL-net, which is a ring topology (physically a bus/star topology) that exchanges signals deterministically. Cyclic transmission is mainly used when connecting a group of controllers, or a system linked with multiple devices, such as an Engineered Safety Features Actuation System (ESFAS). The cyclic transmission mechanism is a token-passing ring, and only one node broadcasts messages sequentially. In this work we propose a token-passing protocol over an Ethernet network architecture for nuclear DI&C. The proposed protocol assumes that the token holds the correct frame transmission, and thus the frame can be deterministic to avoid collisions from the carrier sense multiple access with collision detection (CSMA/CD) architecture. Every node on the network can share the data by using the same memory block, known as the shared memory. Each node on an FL-net has a specific transmission area in the shared memory that does not overlap with those of the others. A transmission area assigned to one node must be receiving area for other nodes. Each node broadcasts its data in a fixed cycle and all the nodes in a network share the same data on the shared memory. Message transmission is controlled so that the refresh time of the shared memory in the cyclic transmission does not exceed the allowable time.

In this environment, each control unit has a shared memory in which to keep the exchanged information. Since the shared memory's cyclic updating time and size are fixed, a shared memory size and cycle time should not exceed a fixed value, and this restriction ensures that the exchanged information received in the communication system is correct. In addition, for reliability [7], from a theoretical viewpoint some control units that are broken and repaired can be seen as failure and recovery events. The proposed system architecture is shown in FIG. 3C, in which it can be seen that the proposed protocol sits on top of the IP layer. The IP layer provides datagram routing from the source to the destination. The proposed token-pass protocol provides the necessary service in order to guarantee that the packets are received correctly and in-time by the receivers. The shared memory is installed inside real-time applications for every node. The contents of the shared memories on every node are identical. The token-pass mechanism ensures that the shared memories are synchronized, and it has the following characteristics to meet the requirements of real-time performance: (a) Only one token exists in the network. When a node receives the token, the node is allowed to transmit frames; (b) The token can be passed with a data frame or by itself; (c) In the event of losing a token, the next node of the token holder is responsible of generating a new token; and (d) When two tokens exist in the network, the node that detects this situation has to drop the token that it is holding.

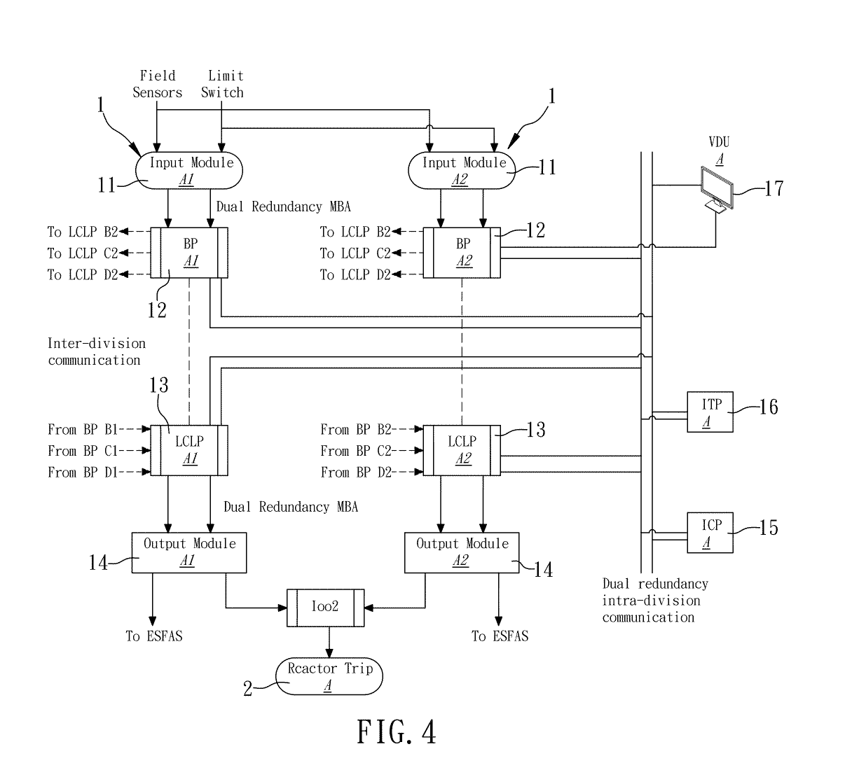

FIG. 3D presents a typical 4-division DRPS 2 can be configured using TaiNICS as FIG. 4. The DPRS 2 is divided into four separate divisions (i.e., division A, B, C, and D). The divisions are physically separate and electrically independent from another division. TaiNICS can be also configured as a dual redundant system to increase its reliability. FIG. 4 shows a preliminary configuration of dual redundant within one single division. Each division 1 is comprised of the dual redundant input module 11, the dual redundant Bi-stable Processor (BP) 12, the dual redundant Local Coincidence Logic Processor (LCLP) 13, the dual redundant output module (1oo2) 14, and Integrated Communication Processor (ICP) 15, and Interface and Test Panel (ITP) 16, and a Video Display Unit (VDU) 17 (Chapin, Douglas M. et al. 1997 Digital Instrumentation and Control Systems in Nuclear Power Plant, Committee on Application of Digital Instrumentation and Control System to Nuclear Power Plant Operations and Safety, National Academy Press, Washington, D.C., US; and Shin, Hyun-Kook, Nam, Sang-Ku et al. 2000 Development of Advanced Digital Reactor Protection System Using Diverse Dual Processors to Prevent Common mode Failure, ANS International Topical Meeting on Nuclear Plant Instrumentation, Controls, and Human Machine Interface Technology (NPIC&HMIT2000), Washington, D.C., November 13-17).

The input module 11 receives analog inputs from sensors and digital signals from hardware switches. The communication interface between I/O modules (input module 11 and output module 14) utilizes customized MBA Bus with high security and robust protocol. Each BP 12 compares the measured signal with the predefined set-point value to determine a trip state and transmits its trip state to LCLPs 13 of the redundant divisions 1 via enhanced RS-485 protocol of peer-to-peer fiber connection deterministically and periodically. The communication module of LCLP 13 processes received signals from BPs 12 and store them to a specified register (not shown) by a dedicated ASIC (not shown), then the main processor of LCLP 13 acquires the signals from BPs 12 by polling the register (not shown) periodically. There is no handshaking between BP 12 and LCLP 13 and no signal from LCLP 13 to BP 12 in inter-division communication.

Each LCLP 13 performs 2oo4 (two-out-of-four) coincidence trip logic and produces a trip signal that is sent to the output module 14 to operate the Reactor Trip 2 and Engineering Safety Feature Actuation System (ESFAS, shown as FIG. 3E) as soon as two or more of BPs 12 are under trip state.

Safety systems and non-safety systems utilizes ICP 15 as communication interface. The ITP 16 is a testing system for performing continuous monitoring and manually initiating automatic testing. VDU 17 is a local display for displaying the operating condition of system in each division 1. Communication between ICP 15, ITP 16, VDU 17, and processor modules 13, 15, 16 uses Cyclic FL-net with dual line fault tolerant fiber network.

Please refer to FIG. 3E, which shows an Architecture of the ESFAS. The digital I&C systems should be designed to perform the following functions: (a) Collecting the measuring value and digital status from local sensors and limit switches; (b) Initialing the digital trip signal by checking the measuring value and digital status; (c) Getting all trip signals from self and other divisions then executing voter logic; (d) Executing the safety control logic if it is triggered by voter logic controller; (e) To be the bridge between 1E and Non-1E communication; and (f) To be the interface between the all 1E system and excite the testing function. The ESFAS in TNICS project is divided into four redundant divisions. The control signal will use inter-division communication module to exchange. However, the protection signal will only use hardware instead of inter-division communication module. All controller list in FIG. 2 and FIG. 3 shall use the FORMOSA-NX, but more detail about how be used in ESFAS is TBD(to be defined).

Please also refer to FIG. 3F, which shows a safety control system architecture. The hardware components consists of power supply modules, main processor module, coprocessor module, input/output modules, inter-division communication module, intra-division communication module, Class-1E/Non-Class-1E communication module, and display unit. Above mentioned hardware components are used in three different scenarios. (1) Controller: The controller consists of main chassis, power supply module, main processor module, inter-division module, intra-division module, coprocessor module and I/O modules. (2) Display unit: The hardware of display unit consists of power supply module, main processor module, and intra-division communication module, and one LCD display screen. (3) 1E/Non-1E gateway: Consists of power supply module, main processor module, intra-division module, and 1E/Non-1E communication module. Besides the scenarios described above, the three kinds of communication module, e.g. the inter-division communication module, the intra-division communication module, and the Class-1E/Non-Class-1E communication module, use the same hardware, but the software inside is different. There are two kind of chassis “Main chassis” and “Sub chassis”. The main chassis is provided to install power modules, main processor boards and communication modules. On the other side, the power modules, coprocessor modules and input/output modules are installed in the sub chassis.

The most important methodology is focusing on the intra-division communication system. Controllers, human machine interface displays and other devices are linked through the communication system. Although the token-pass based protocol, ether 802.4 or 802.5, has been developed and applied to the industries for decades, special cabling and hardware are needed to support this protocol. On the other hand, the Ethernet hardware is popular and easy accessed. It is used in this invention to implement token-pass protocol. In order to resolve the non-deterministic characteristic of Ethernet, token passing mechanism is disclosed in this invention. When the time that each node holds the token is fixed, the maximum data transmission time can be determined. Thus, the real-time performance can be guaranteed. The token-pass mechanism has been applied to several industrial communication protocols, e.g., Modbus plus, token ring, etc. The token-pass mechanism is a type of media access method where a special frame call a token is passed from station to station that enables the station to transmit frames. A token is a special frame that gives a node on the network the access permission to the transmit frames on the network. Since only one token is allowed in the network at any time, no collision will occur.

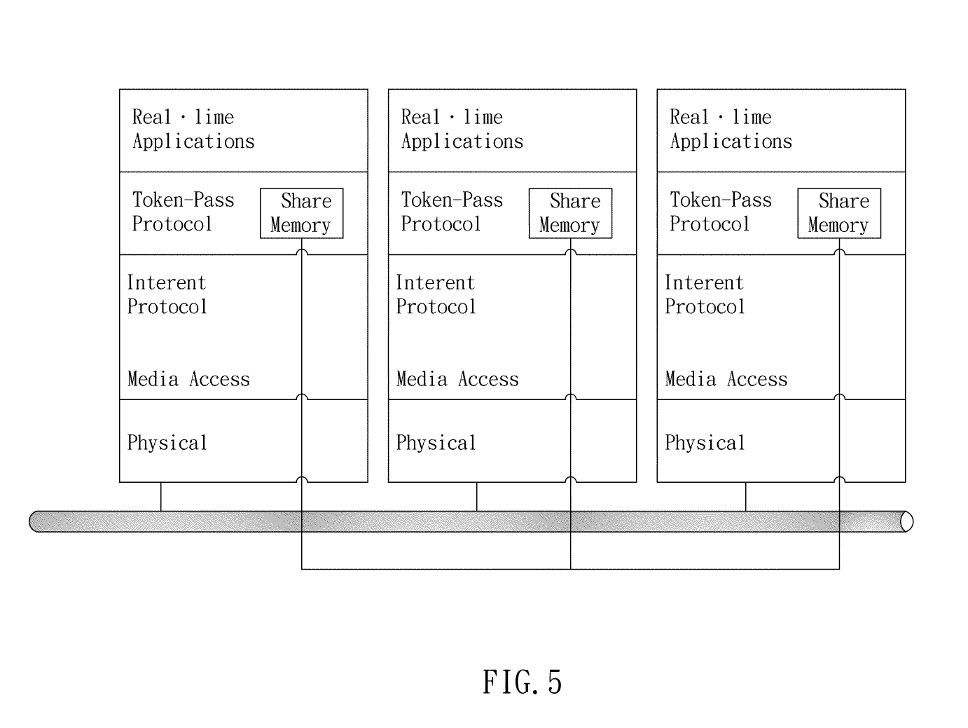

Please refer to FIG. 5, which shows a system architecture of Ethernet based token pass protocol. The protocol 100 is sit on top of IP layer. The IP layer provides datagram routing from the source to the destination. The token-pass protocol 101 provides necessary service in order to guarantee that the packets are received correctly and in-time by the receivers. The shared memory 102 is installed inside Real-Time applications 103 for every node. The contents of the shared memories 102 on every node are identical. The token-pass mechanism ensures that the shared memories 102 are synchronized. There are several advantages of using Ethernet as the physical and MAC layer. First, the hardware can be easily accessed by users as mentioned earlier. Second, new data can be done by broadcasting through the bus topology. The broadcast of packet can reduce the network traffic when the number of nodes increases. As a result, the performance can be improved. The disadvantages of Ethernet such as non-deterministic frame passing can be resolved by applying token-passing mechanism. The round-robin scheduling is provided by the token passing mechanism. When the size is the same for all the data frames, the scheduling can be considered as max-min fair. Since only the token holder can transmit frames, the frame collision can be avoided. As a result, the net work bandwidth can be fully utilized when the traffic is heavy. The maximum waiting time of each node can be determined since the maximum token holding time for each node is specified in advanced. The token-pass mechanism has following characteristics to meet the real-time performance: 1) Only one token exists in the network. When a node receives the token, the node is allowed to transmit frames. 2) The token can be passed with data frame or by itself. 3) In the event of losing token, the next node of the token holder is responsible of generating a new token. 4) When two tokens exist in the network, the node that detects this situation has to drop the token.

In order to evaluate the performance of token-based protocol, simulation is needed. NS2 (Network Simulator version 2) is a discrete event network simulator. Development of NS2 was supported by DARPA and various organizations since 1995. NS2 is a discrete-event driven simulator that was developed based on C++ and OTcl (Object-oriented Tool Command Language). Comparing with traditional simulation environment, NS2 is able to simulate large scale networks with less efforts and resources. The network protocols such as TCP and UDP can be simulated in NS2. MAC layer protocols for various kinds of LANs can also be simulated by NS2. The text-based simulation trace results provide precise timing information that can be used for analyzing network performance.

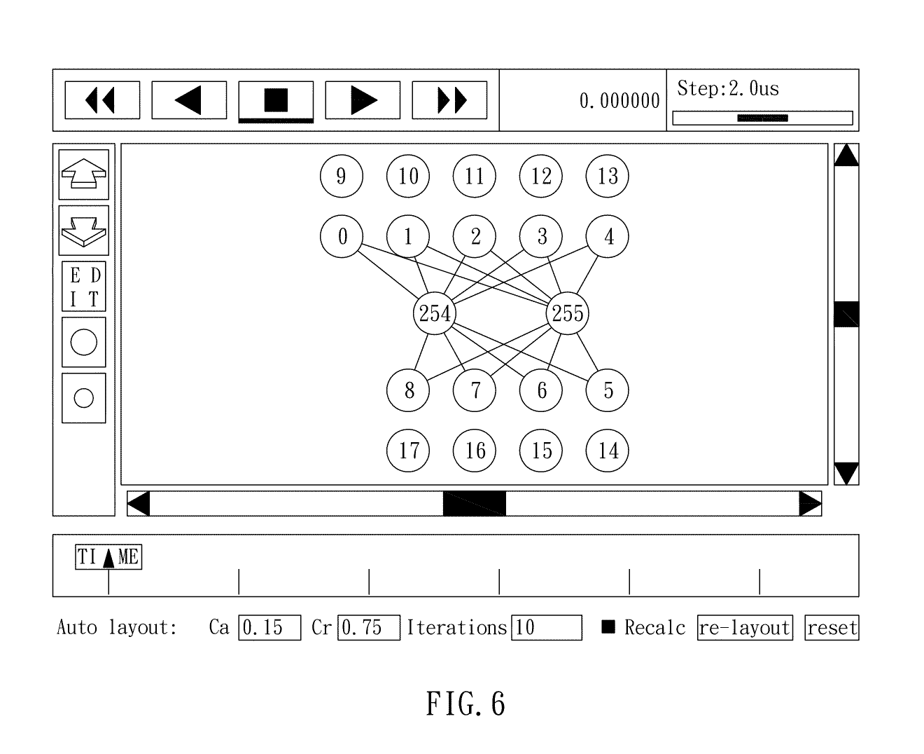

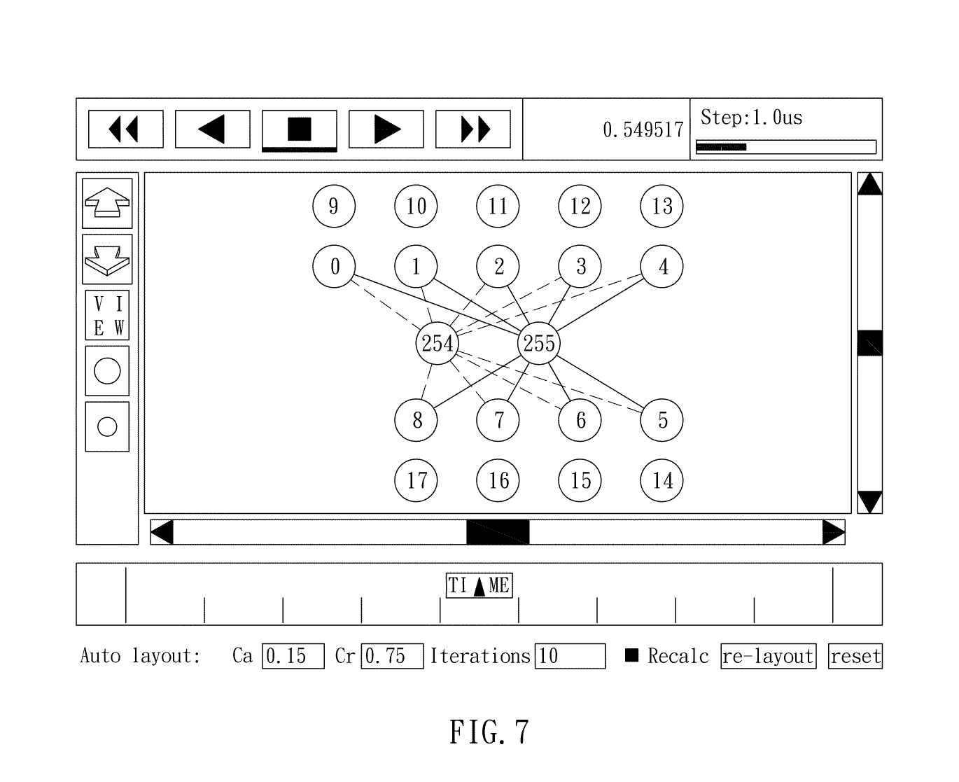

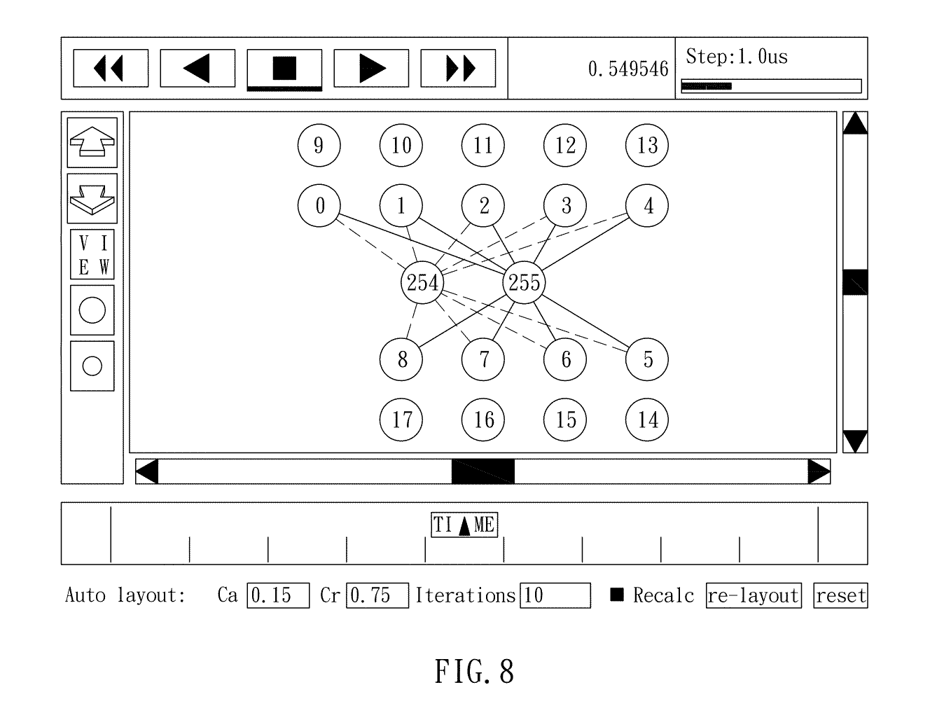

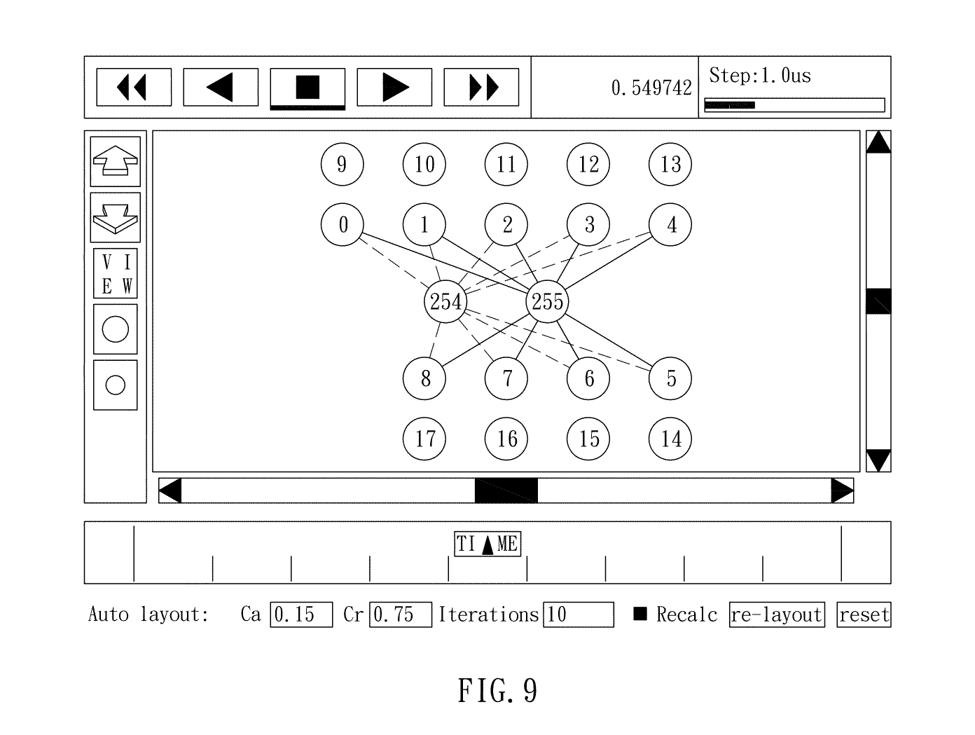

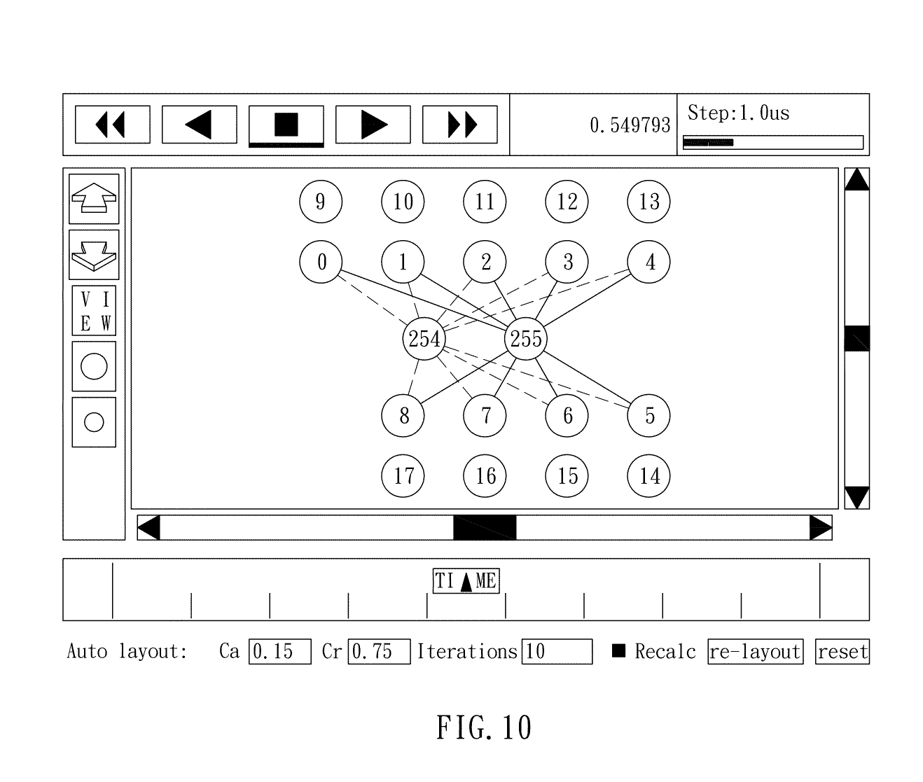

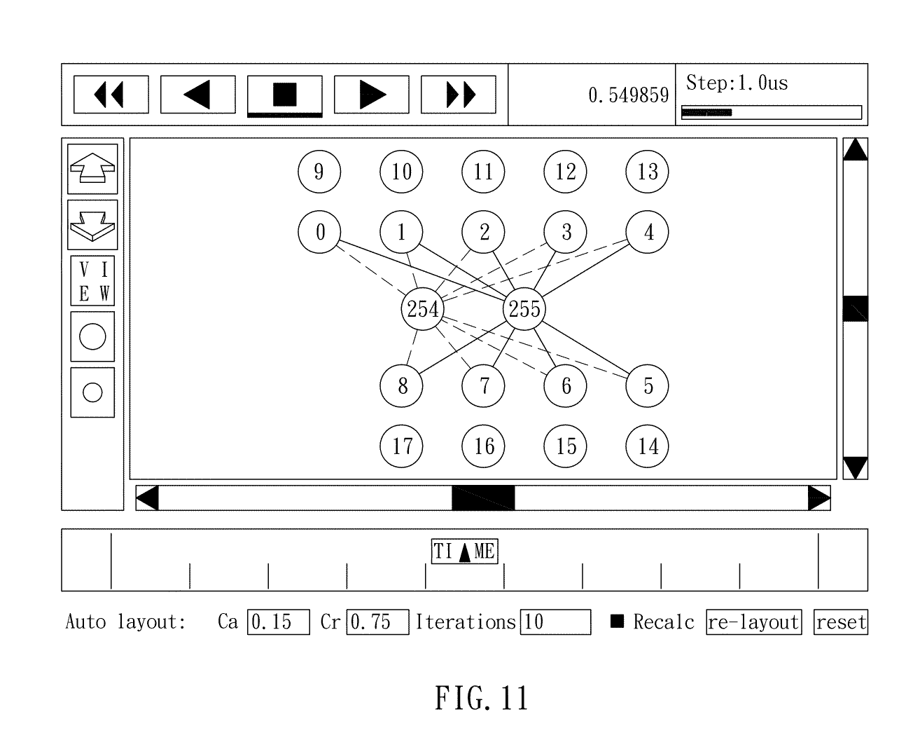

There are three major steps when applying NS2 for simulating new protocol: 1) Development of simulation scenario and network topology; 2) Setting up parameters, e.g., network speed, number of nodes, etc.; 3) Analyze the simulation results based on event trace file generated by NS2. To simulate the IV environment, a scenario is developed in NS2. Please refer to FIGS. 6 to 11, which respectively show the bus model of the Ethernet, a packet is sent from node 2, node 255 broadcasts the packet, other nodes receive the packet, a packet is sent from node 3, and node 255 broadcasts the packet. The token-pass mechanism is added in each node to avoid the frame collision. Logic ring topology is formed by applying the token-pass mechanism.

From the previous model, control units which include node 9 to 17 transmit packets in round-robin turn for exchanging information by broadcasting packets from one of the two switch-hubs. However, if the transmitted control unit or broadcast switch hub fails, a control unit's packets can not arrive to others until failed things are recovered. Thus, packets will stay in the control unit queue and cause the queuing delay. Theoretically, the control unit or switch hub fails because of impacts of fails events. Then, they will be recovered by waiting for impacts of recovery events. Besides, the time of failure or recovery events can not be predicted so that it is set in a random generation distribution, e.g., an exponential distribution, pareto distribution, etc.

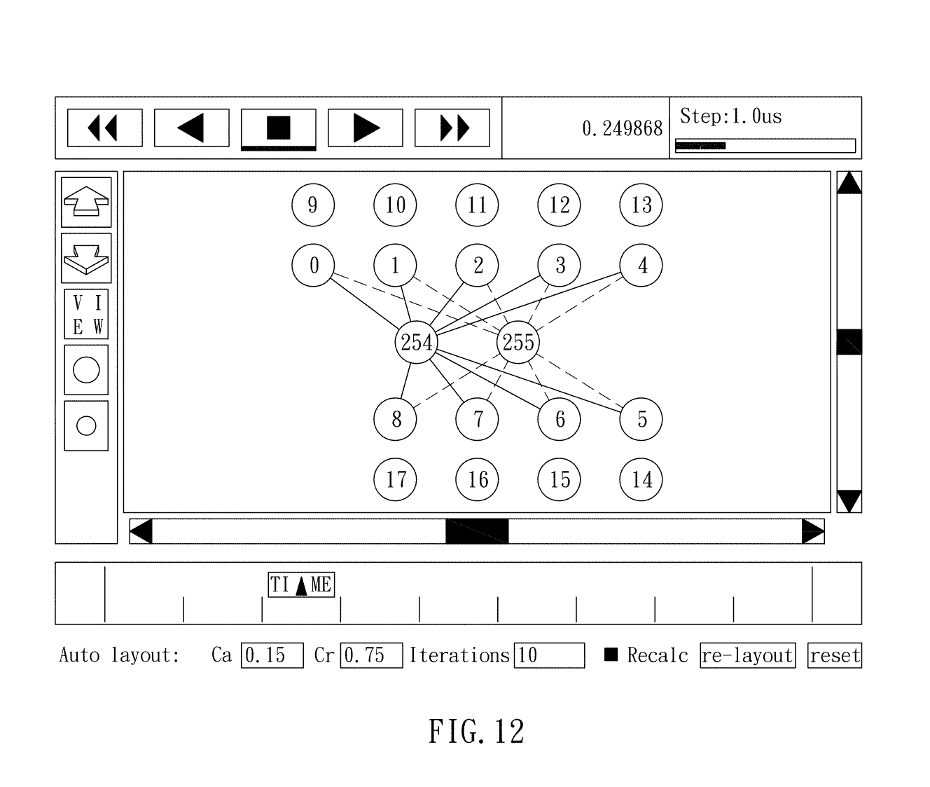

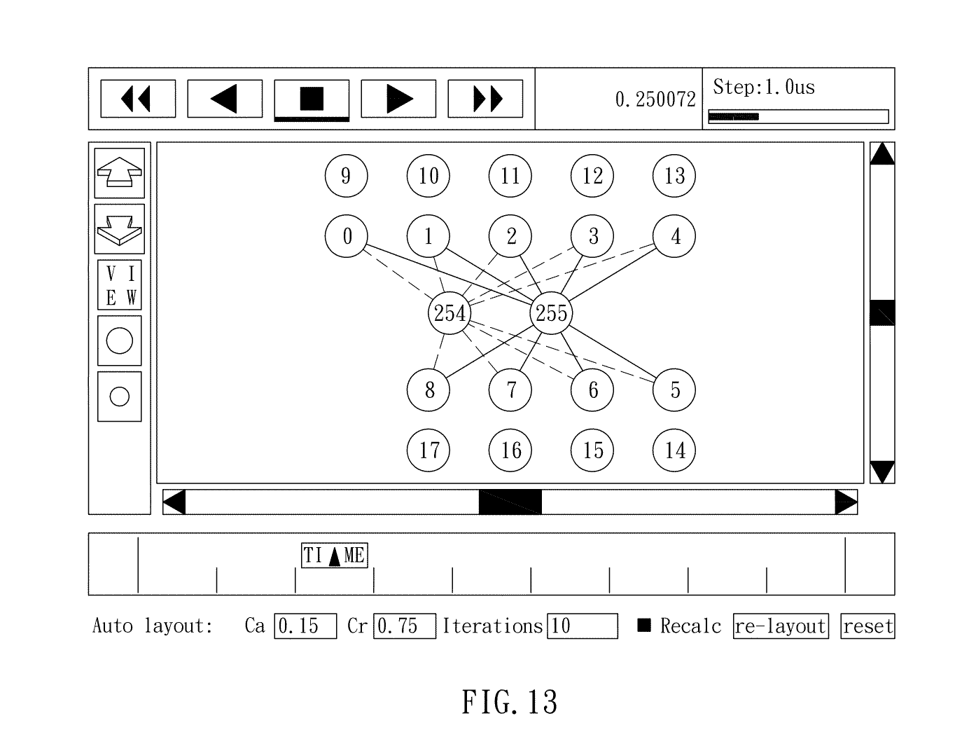

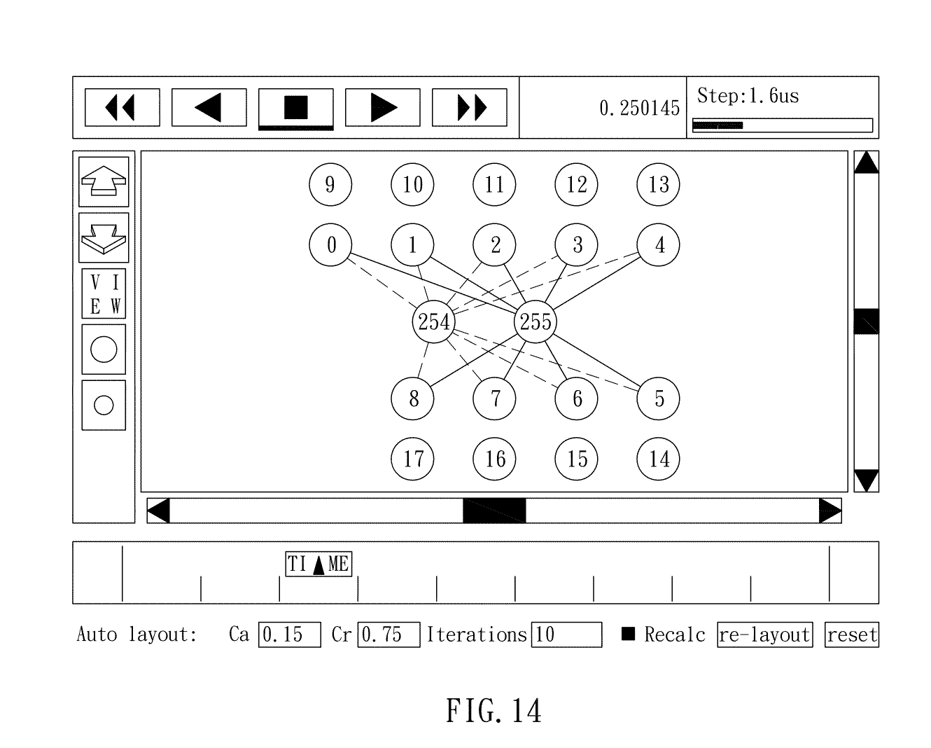

For failure-recovery event scenarios, there are four major situation when applying NS2 for simulating new protocol with failure and recovery events: 1) A switch-hub's failure events; 2) A switch-hub's recovery events; 3) Control units' failure events; 4) Control units' recovery events; As for switch-hub's failure events. In FIG. 12, node 254 broadcasts a packet. FIG. 13 shows node 254 fails and node 255 is active. In FIG. 14, a packet is sent from node 2.

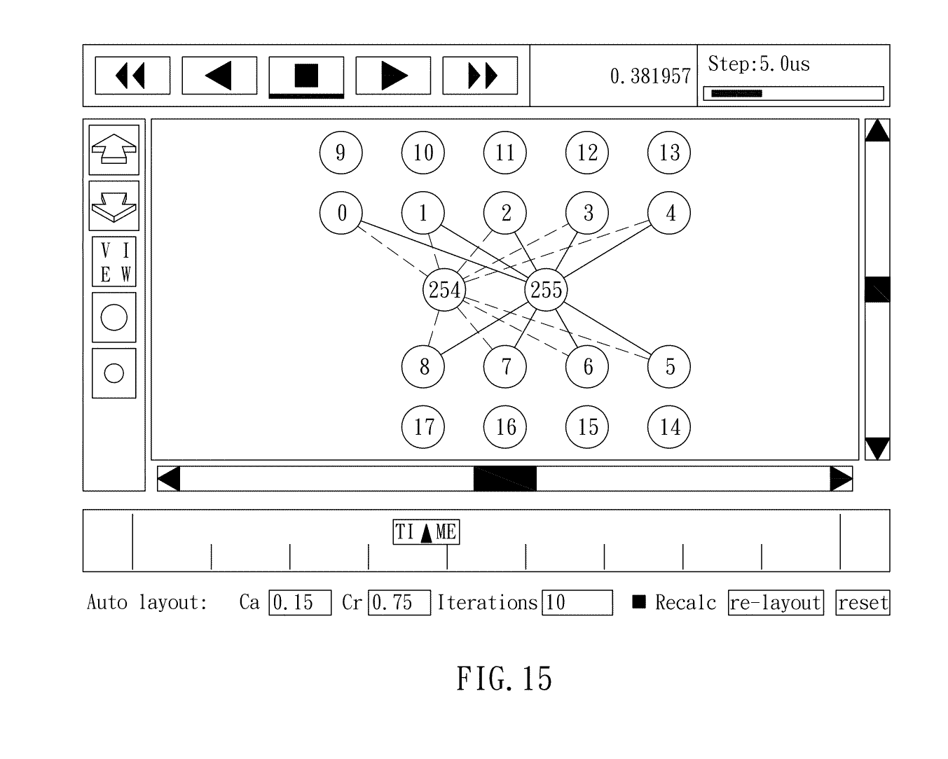

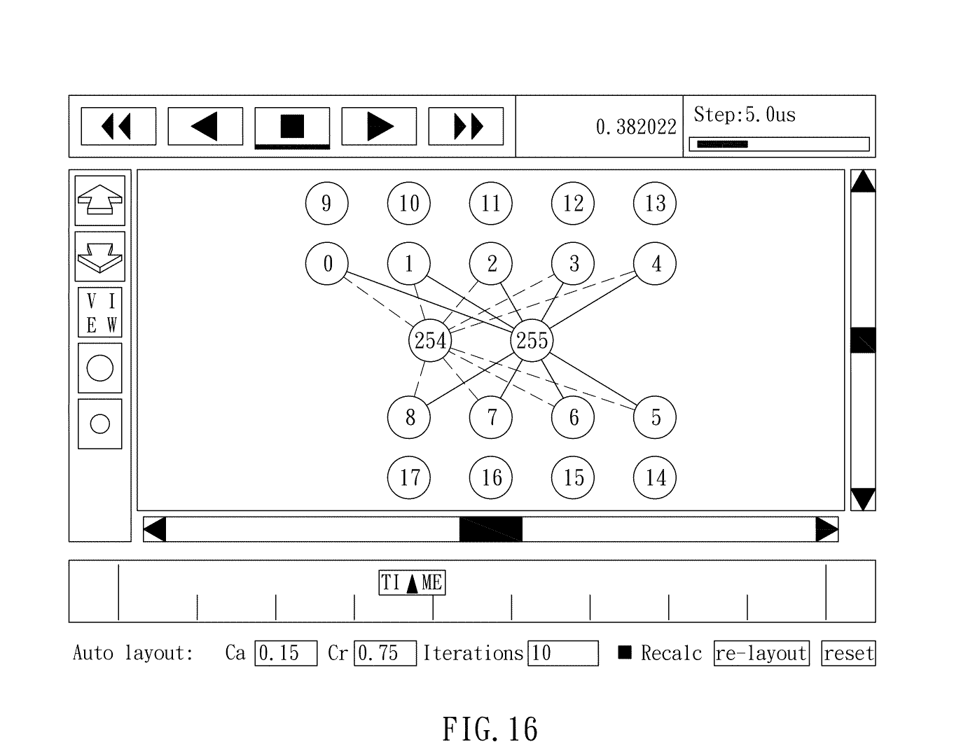

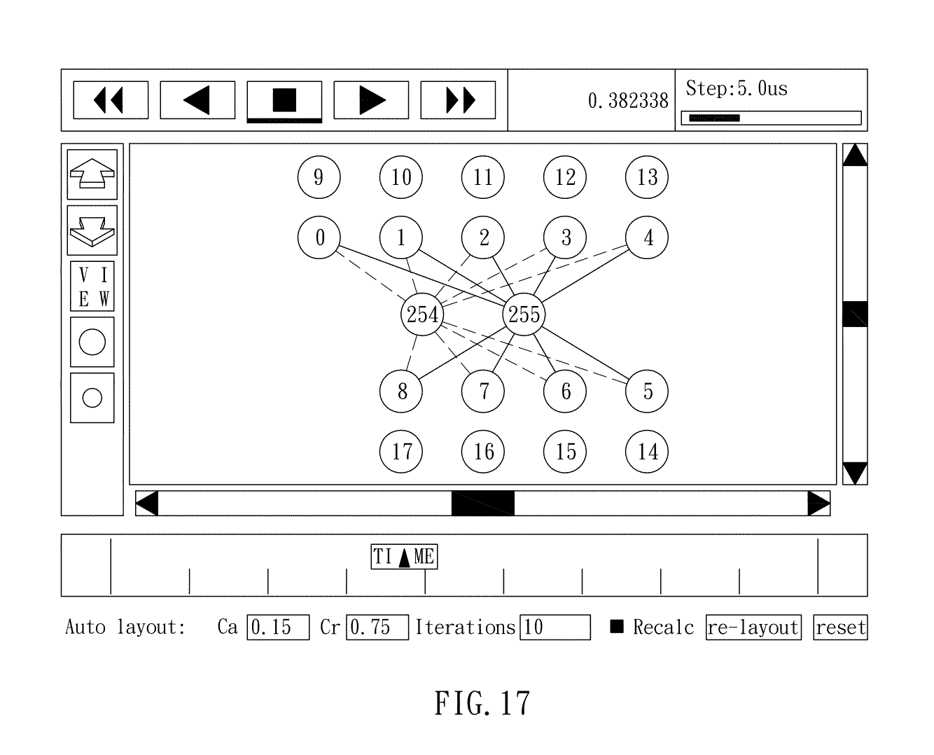

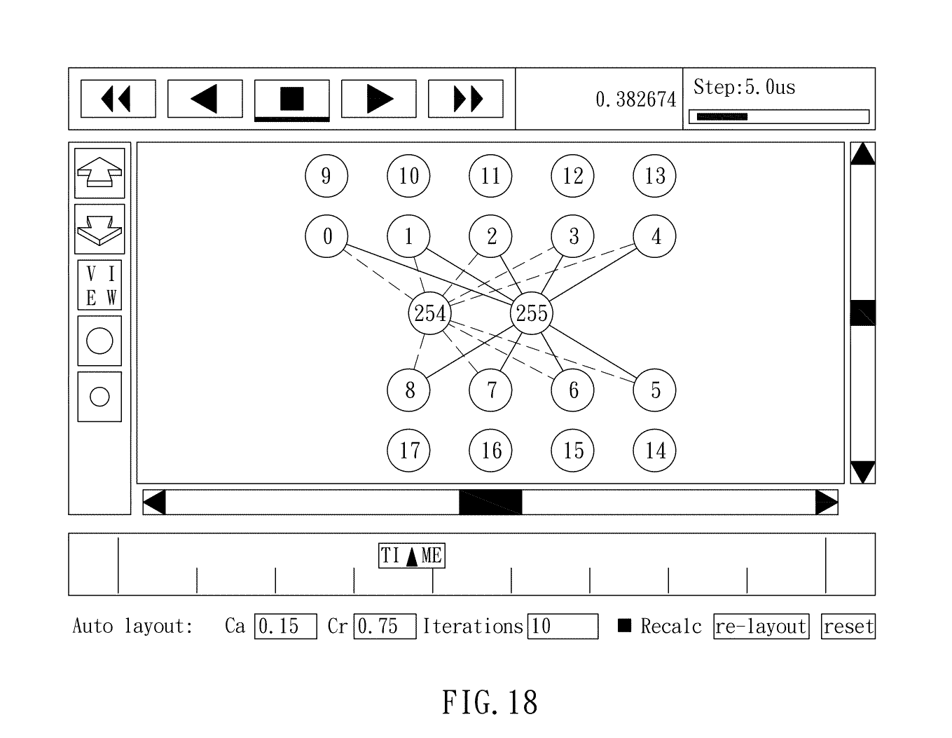

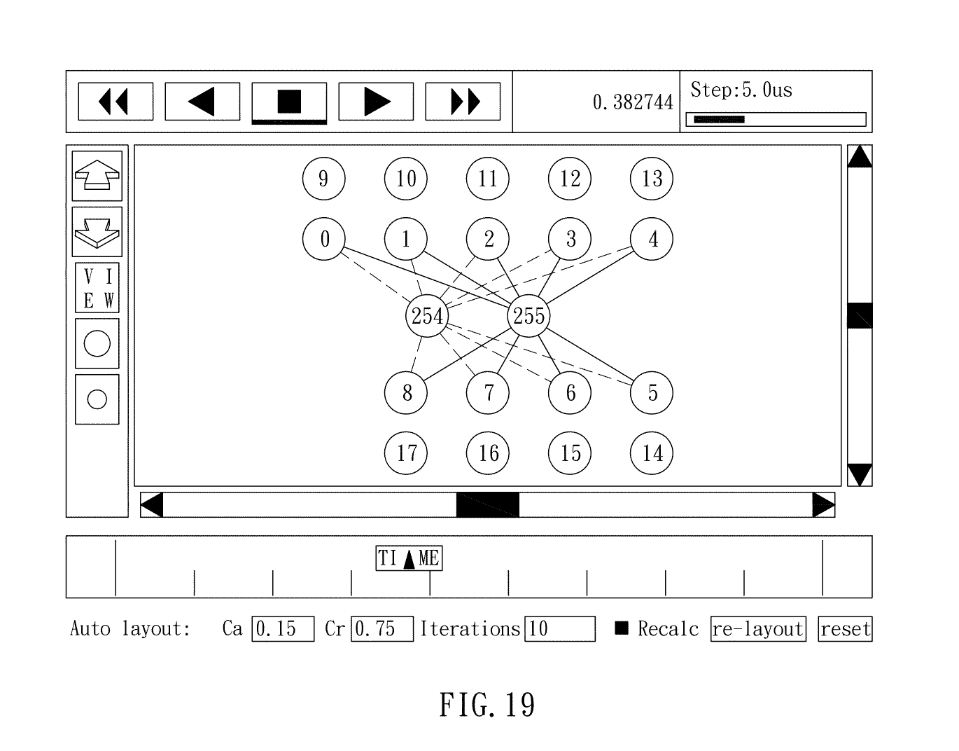

As for control units' failure events, FIG. 15 shows a packet is sent from node 3. FIG. 16 shows node 255 broadcasts packets. In FIG. 17, nodes 4 and 5 fail. FIG. 18 shows a packet a packet is sent from node 6. FIG. 19 shows node 255 broadcasts the packet.

Token-pass bus protocol is discussed as a solution of the nuclear instrument and control environment application in FA control network (FL-net) protocol issues. FL-net is the FA link protocol based on Ethernet. The FA link protocol is intended for the FL-net to be used for exchange information between various control units in nuclear systems. FL-net uses a token bus topology, but it needs more requirements. Each control unit has the individual share memory with fixed size. While a unit receives cyclic broadcast bytes, the total bytes should not exceed the fixed size. Otherwise, the common memory will be broken. Besides, the common memory has upper bound of cyclic updating time which the token bus cyclic transmission time can't exceed. Otherwise, the common memory will update the inefficient information in the token-pass bus network with the fixed cyclic packet size.

For the FL-net protocol simulation, the simulation parameters are set. The 512K common memory size and 20 ms cyclic updating time are set for common memory. 100 Mbps bus bandwidth and the 100 bytes packet size are set as transmission condition simulation parameters. The application target is a 10 meter nuclear card with 9 control units in a token-pass bus topology. Two comparable packet types are Poisson and constant bit rates (CBR) distribution. As for reliability, because the random number distribution may exceed the period of simulation time or overlap in a short period. So, the failure-recovery period is set to 1 ms which is in minimum ms-scale. Simulation time is 1 s.

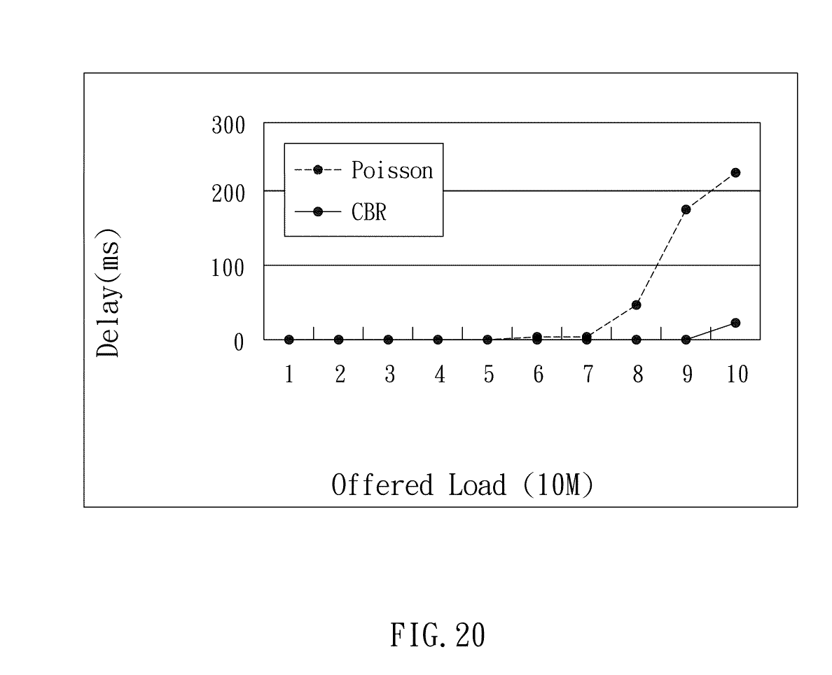

FIG. 20 shows the queuing delay performance without failure-recovery events in different offered loads. Because of the stable CBR distribution, the CBR delay is 24.80 ms in the 100M offered load. The poisson delay is 225.30 ms since the Poisson distribution includes various probabilities of packet numbers. While high packets numbers appear in a period, queuing delay increases. On the worst case, packet drops will appear and cause missed packet transmission.

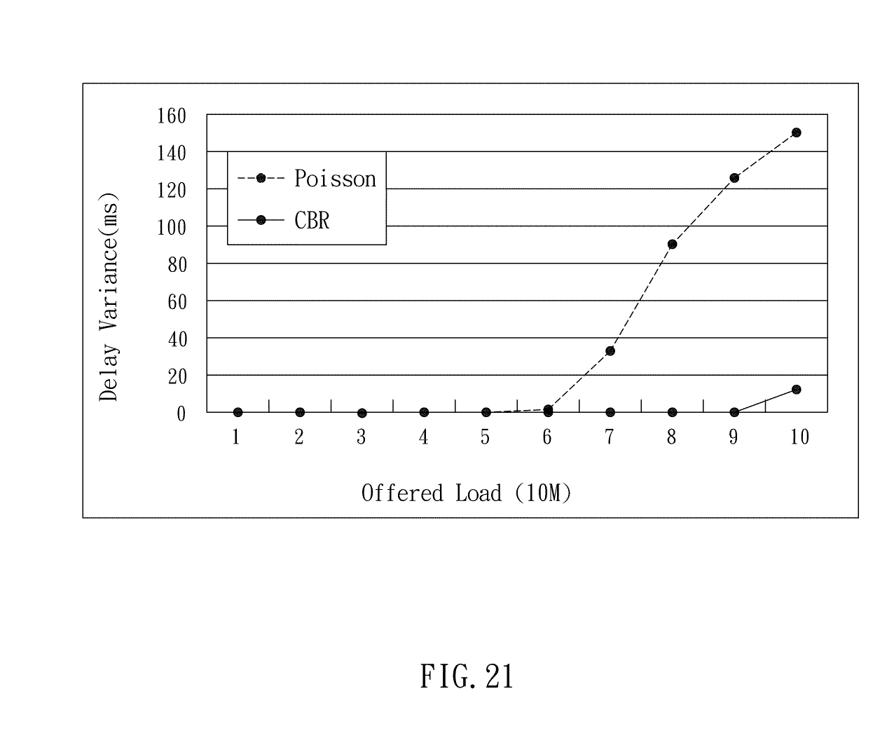

FIG. 21 is the queuing delay variance performance diagraph in different offered loads. Because of the stable CBR distribution and small token rotation time, the CBR delay variance is 11,12 ms in the 100M offered load. The Poisson distribution's delay variance is 148.88 ms since the Poisson distribution includes various probabilities of packet numbers. In the 100M offered load, packets in queue increase the queue length and cause packet drops in the worst case.

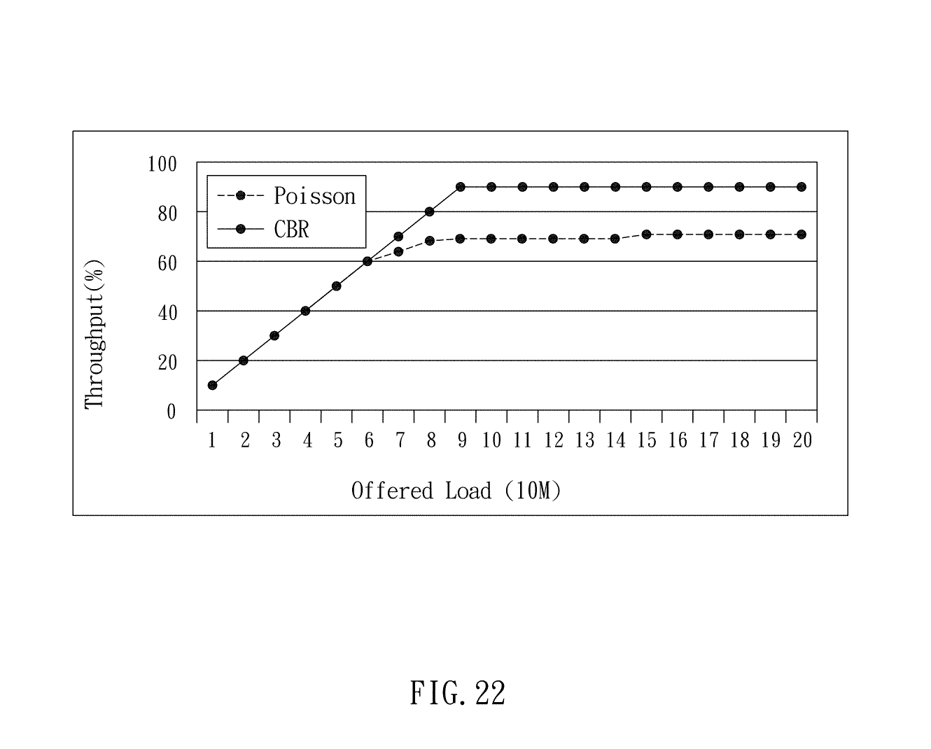

FIG. 22 shows throughput performance in different offered loads. Because of the stable CBR distribution, the CBR throughput is 89.5 percents in the 90M offered load. The Poisson throughput is 67.9 percents since the Poisson distribution includes various probabilities of packet numbers. While high packet numbers appear in a period, queuing delay increases. In the worst case, packet drops will appear and cause missed packet transmission.

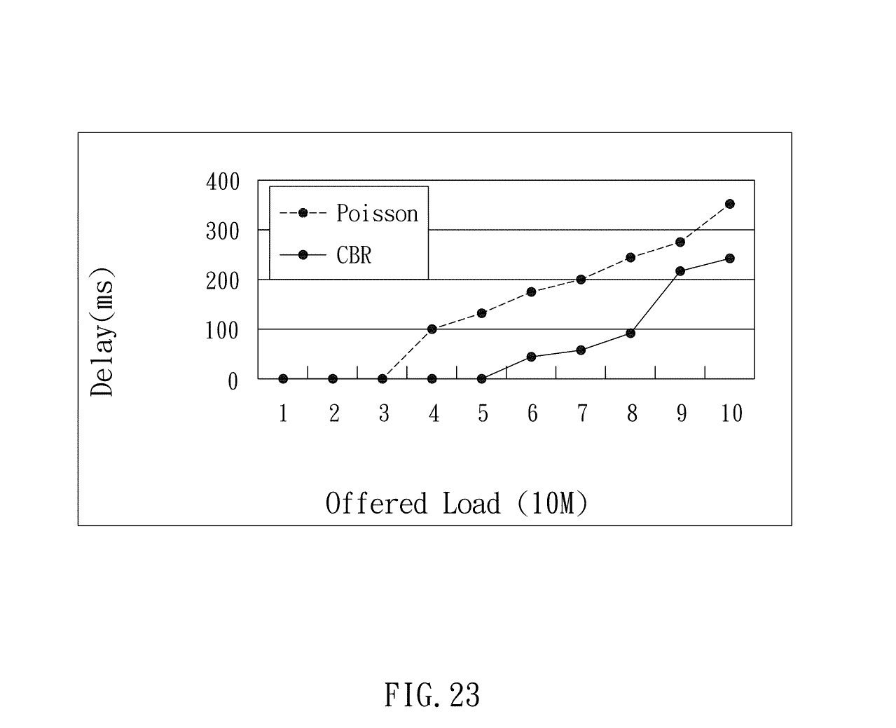

FIGS. 23 to 25 show the control units' reliability in performance evaluation. Time of failure events and time of recovery events are both in the exponential distribution. Two comparable packet types are Poisson and constant bit rates (CBR) distribution in delay, delay variance, and throughput.

FIG. 23 is the delay performance diagraph with exponential distribution control units' failure-recovery events time in different offered loads. Failure event time is set as exponential distribution with 0.5 s mean. When the failure event time is determined, recovery event time is set behind it as an exponential distribution with lms mean. Within the period of failure event and recovery event time, control units can not send any packet from control units' queues, but packets still inject into queues. As a result, delay with failure-recovery events is higher than delay without failure-recovery events. The CBR delay is 243.21 ms in the 100M offered load and the Poisson distribution's delay is 352.13 ms since the Poisson distribution includes various probabilities of packet numbers. In the 100M offered load, packets in queue increase the queue length and cause packet drops in the worst case.

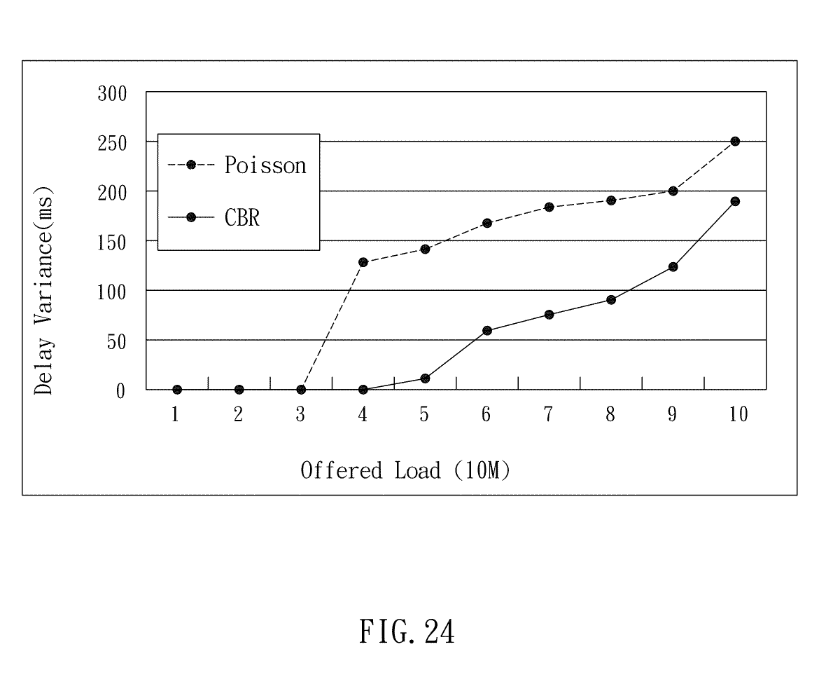

FIG. 24 is the delay variance performance diagraph with exponential distribution control units; failure-recovery event time in different offered loads. Since the Poisson distribution includes various probabilities of packet numbers, packet bytes in the queue are not stable and cause a higher queuing delay variance then the CBR distribution. The CBR delay variance is 183.02 ms and the Poisson delay variance is 250.43 ms in the 100M offered load.

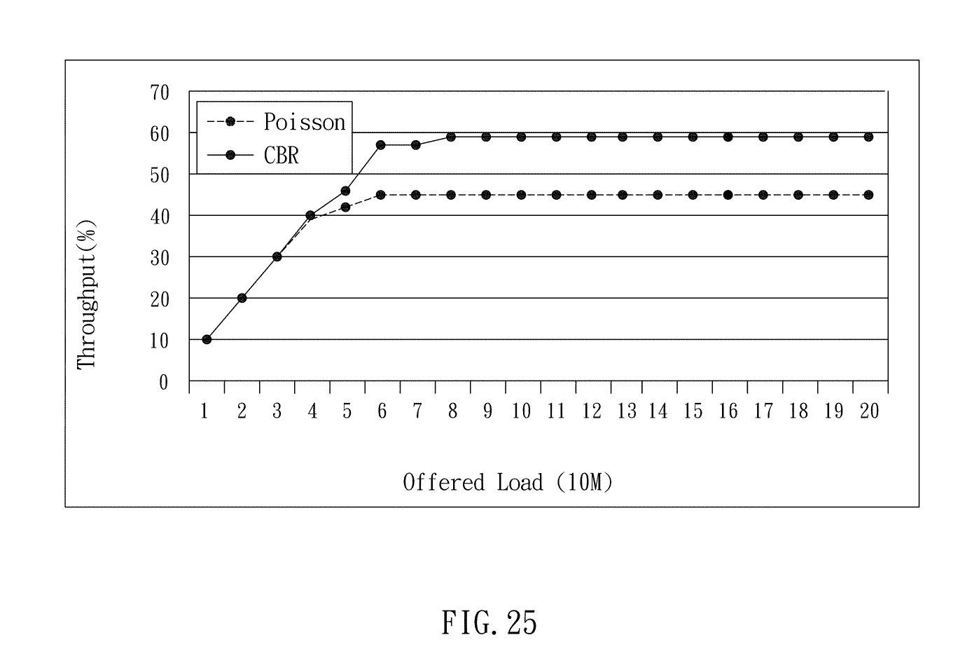

FIG. 25 shows throughput performance in different offered loads. Because of the stable CBR distribution, the CBR throughput is 58.7 percents in the 90M offered load. The Poisson throughput is 45.3 percents since the Poisson distribution includes various probabilities of packet numbers. While high packet numbers appear in a period, queuing delay increases. In the worst case, packet drops will appear and cause missed packet transmission.

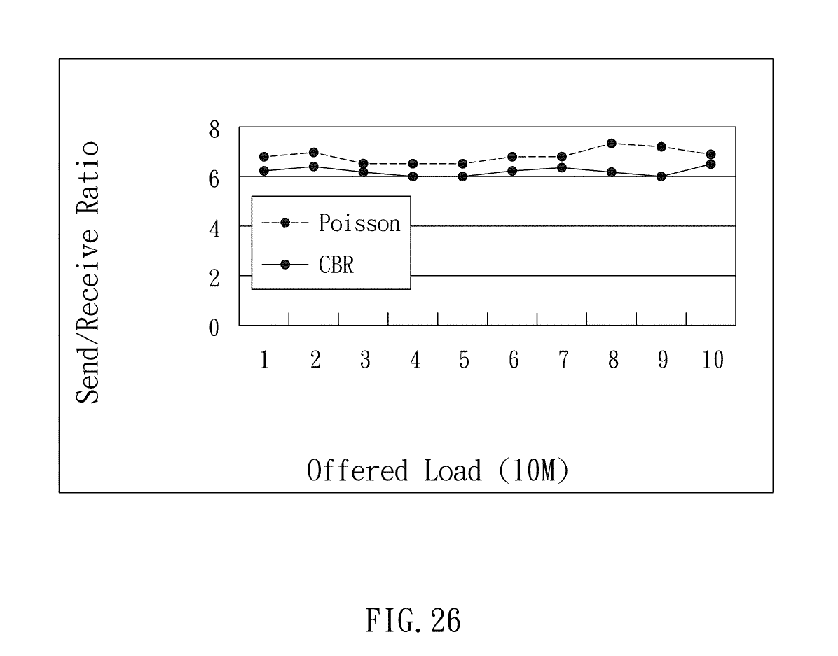

FIG. 26 is the switch-hub's reliability in performance diagraph with or without switch-hub's failure event. A switch-hub's failure event is simulated with 1 ms constant period at 249 ms simulation time. The switch-hub is broken within the period and can not broadcast any packet. Then, FIG. 26 is the ratio of switch-hub/receive accumulative packets. Without failure events, the ratio should be 8 because the switch-hub receives one node's packet and send to other 8 nodes from time to time. However, with failure events, 1 ms period in CBR and Poisson distribution's ratio is 6.10 and 6.53 which are both lower than 8 because of the distribution's density within the 1 ms period from 249 ms to 250 ms. CBR distribution's density is constant but Poisson distribution's one is not. FIG. 26 indicates POISSON distribution's density is lower than CBR distribution's one. So, Poisson distribution's ratio is higher than CBR distribution's one.

The Ethernet was developed for decades. The transmitting speed of the Ethernet has been improved dramatically since it was introduced. The hardware and software can be assessed easily. Although the original Ethernet is not suitable for real-time applications, it can be modified by adding token-pass mechanism so the non-deterministic characteristics can be avoided. In order to verify and validate the protocol in this invention can be applied to real-time instrument and control environment, NS2 simulation is performed. Some preliminary results were obtained.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A nuclear instrumentation and control system, comprising:
an input module, receiving analog inputs from sensors and digital signals from hardware switches;
a dual redundant bi-stable processor, connecting to the input module;
a dual redundant local coincidence logic processor, connecting to the dual redundant b0-stable processor;
an output module, connecting to the dual redundant local coincidence logic processor;
an integrated communication processor, connecting to the dual redundant bi-stable processor and the dual redundant local coincidence logic processor;
an interface and test panel, connecting to the dual redundant bi-stable processor, the dual redundant local coincidence logic processor and the integrated communication processor; and
a video display unit, connecting to the dual redundant bi-stable processor, the dual redundant local coincidence logic processor, the integrated communication processor and the interface and test panel.

2. The nuclear instrumentation and control system as claimed in claim 1, wherein the communication interface between the input module and the output module is utilizing a customized MBA Bus with high security and robust protocol.

3. The nuclear instrumentation and control system as claimed in claim 1, wherein the dual redundant bi-stable processor compares a measured signal with a predefined set-point value to determine a trip state and transmits its trip state to the dual redundant local coincidence logic processor via an enhanced RS-485 protocol of peer-to-peer fiber connection deterministically and periodically.

4. The nuclear instrumentation and control system as claimed in claim 1, wherein the dual redundant local coincidence logic processor processes received signals from the dual redundant bi-stable processor and store them to a specified register by a dedicated ASIC, then the dual redundant local coincidence logic processor acquires the signals from dual redundant bi-stable processor by polling the register periodically.

5. The nuclear instrumentation and control system as claimed in claim 4, wherein there is no handshaking between the dual redundant bi-stable processor and the dual redundant local coincidence logic processor and no signal from the dual redundant local coincidence logic processor to the dual redundant bi-stable processor in inter-division communication.

6. The nuclear instrumentation and control system as claimed in claim 1, wherein the dual redundant local coincidence logic processor performs 2oo4 (two-out-of-four) coincidence trip logic and produces a trip signal that is sent to the output module to operate a Reactor Trip and an engineering safety feature actuation system as soon as two or more of the dual redundant bi-stable processor is under a trip state.

7. The nuclear instrumentation and control system as claimed in claim 1, wherein the integrated communication processor is a communication interface for Safety systems and non-safety systems.

8. The nuclear instrumentation and control system as claimed in claim 1, wherein the interface and test panel is a testing system for performing continuous monitoring and manually initiating automatic testing.

9. The nuclear instrumentation and control system as claimed in claim 1, wherein any one of the integrated communication processor, the dual redundant bi-stable processor, and the dual redundant local coincidence logic processor has five software modules, which are including a controller logic module, a multiple bus access module, a FL-net module, a vital communication module, and a kernel.

10. The nuclear instrumentation and control system as claimed in claim 1, wherein the communication between the integrated communication processor, the interface and test panel, the video display unit, the dual redundant bi-stable processor, and the dual redundant local coincidence logic processor uses a Cyclic FL-net with dual line fault tolerant fiber network.
